(19) United States
(12) Patent Application Publication
(10) Pub. No.: US 2012/0173979 A1
(43) Pub. Date: Jul. 5, 2012

(54) REMOTE CONTROL SYSTEM AND METHOD WITH ENHANCED USER INTERFACE

(75) Inventor: Keith Markkel Lee, Delray Beach, FL (US)

(73) Assignee: OPENPEAK INC., Boca Raton, FL (US)

(21) Appl. No.: 12/983,140

(22) Filed: Dec. 31, 2010

(51) Int. Cl. G06F 3/01

(52) U.S. Cl. 715/719; 715/740

(57) ABSTRACT

A remote control system and method for a multi-media device, such as a television, is provided. The remote control device includes a display. The remote control device can be a tablet computer, a laptop computer or a smart phone. When an application software program is initiated on the multi-media device, one or more user interface elements are presented on the display of the remote control device. The user interface elements are relevant to the initiated application software program. One or more of the user interface elements can be manipulated such that the application software program adjusts in response. The system and method can provide an adaptive and/or customizable user interface that is appropriate for the application software that is initiated, thereby enhancing user interaction.

### FIELD

Embodiments relate in general to the remote control of multi-media devices and, more particularly, to a user interface for the remote control of multi-media devices.

### BACKGROUND

The use of application software (known as “apps”) on mobile devices, such as smart phones, is very popular. Currently, there is an industry trend toward developing apps for use on other multi-media devices, such as set top boxes and televisions. Remote control devices are being developed to control such devices. However, in view of the virtually unlimited number of possible apps for multi-media devices, a standard user interface provided by a remote control may be unsuitable for some apps or, at a minimum, may make the interface awkward and/or cumbersome for the user. Thus, there is a need for a user interface system and method that can minimize such concerns.

### SUMMARY

In one respect, embodiments are directed to a method for remotely controlling a multi-media device. According to the method, an application software program is initiated via a processor. The processor can be located on the multi-media device, a peripheral device operatively connected to a multi-media device and/or on a remote source.

The application software program is displayed on a multi-media device. A set of user interface elements are presented on a remote control device, such as by displaying the set of user interface elements on the remote control device. The set of user interface elements is relevant to the application software program. The set of user interface elements can include one or more user interface elements.

The set of user interface elements can be fixed. In such case, the set of user interface elements does not change during the activation, loading or operation of the application software program. Alternatively, the set of user interface elements can be dynamic. In one embodiment, the method can further include the step of modifying the set of user interface elements during the activation, loading or operation of the application software program. The method may further include the step of customizing the set of user interface elements.

The method can further include the step of manipulating the set of user interface elements. The application software program can adjust responsive to such manipulation.

The set of user interface elements for the application software program can be stored in a source external to the remote control device. In such case, the method can further include the step of accessing the set of user interface elements from the source external to the remote control device. Alternatively, the method can further include the step of transmitting the set of user interface elements from the source external to the remote control device for presentation thereon. The source external to the remote control device can be the multi-media device, a peripheral device operatively connected to the remote control device and/or a remote server or other suitable source.

The set of user interface elements can be stored on the remote control device. In such case, the method can include the step of accessing the set of user interface elements from the remote control device.

In another respect, embodiments are directed to a remote control device. The device has a display. The device further has a transceiver for transmitting data to and receiving data from a multi-media device and/or a peripheral device operatively connected to a multi-media device. The transceiver can be a wireless transceiver.

A set of user interface elements are presented on the display when an application software program is initiated for display on the multi-media device. The set of user interface elements are relevant to the application software program. The set of user interface elements can be predetermined. The set of user interface elements can include one or more user interface elements.

The remote control device can be any suitable device. For instance, the remote control device can be a remote control, a laptop computer, a tablet computer and a smart phone.

The set of user interface elements can be stored in a source external to the remote control device. The transceiver can be configured to access the set of user interface elements from the source external to the remote control device and/or receive the set of user interface elements transmitted from the source external to the remote control device.

The remote control device can include a processor and a memory. The set of user interface elements can be stored in the memory. The processor can be operatively connected to access the set of user interface elements from the memory for presentation on the display when an application software program is initiated for display on the multi-media device.

In still another respect, embodiments are directed to a remote control system. The system includes a multi-media device having a display. The system further includes a processor for initiating an application software program for display on the multi-media device. In one embodiment, the processor can be resident in the multi-media device. The system includes a remote control device.

The remote control device has a display and a transceiver. The transceiver is configured to transmit data to and receive data from the multi-media device. The transceiver can be a wireless transceiver.

The remote control device is configured to present a set of user interface elements on the display when an application software program is initiated for display on the multi-media device. The set of user interface elements are relevant to the application software program. The application software program can be responsive to manipulation of the set of user interface elements. The set of user interface elements can include one or more user interface elements.

The system can further include a peripheral device operatively connected to the multi-media device. In one embodiment, the processor can be resident in the peripheral device. In such case, the transceiver can be configured to transmit data to and receive data from the peripheral device. The peripheral device can be any device which can operatively connect to the multi-media device to provide content or applications thereto. In one embodiment, the peripheral device can be a set-top box.

The set of user interface elements can be stored in any suitable location. In one embodiment, the set of user interface elements can be stored in a source external to the remote control device, such as in the multi-media device, peripheral device and/or a remote source. In such case, the remote control device is configured to access the set of user interface elements from the source or receive the set of user interface elements from the source.

In yet another respect, embodiments are directed to a multi-media device, which can be, for example, a television 16, a smart TV or a connected TV. The multi-media device can include a display adapted for presenting application software programs on it. The multi-media device can include a transceiver for transmitting data to and receiving data from a remote control device. The remote control device can be operatively connected to the multi-media device. When an application software program is launched for display on the multi-media device, the device can cause a set of one or more user interface elements that are relevant to the application software program to be displayed on the remote control device.

The device can further include a processor for accessing or executing an application software program. The device can also include memory. An application software program can be stored in the memory. The processor can be operatively connected to access and/or execute the application software program stored in the memory.

The transceiver can be configured to transmit the set of user interface elements to the remote control device. Alternatively or in addition, the transceiver can be configured to access the set of user interface elements from a source external to the multi-media device.

### BRIEF DESCRIPTION OF THE DRAWINGS

FIG. 1 is a diagrammatic view of a remote control multi-media system.

FIG. 2 is a diagrammatic view of a multi-media device.

FIG. 3 is a diagrammatic view of a remote control device.

FIG. 4 is a method for providing an enhanced user interface for a remote control device.

### DETAILED DESCRIPTION

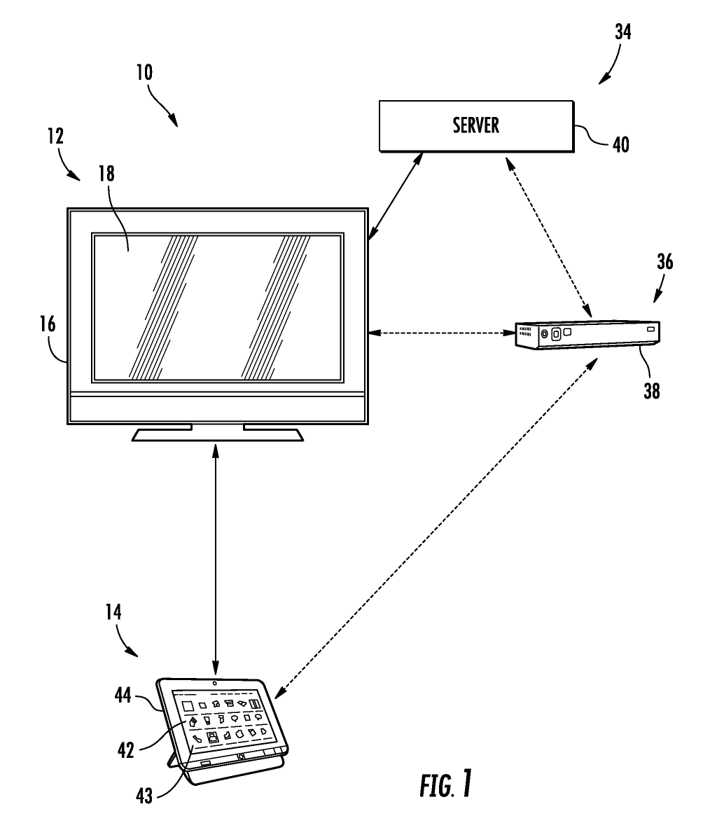

Arrangements described herein relate to a remote control system and method that provides an adaptive and/or customizable user interface depending on the particular application software program being executed on a multi-media device at any given time. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Arrangements are shown in FIGS. 1-4, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary remote control system 10 is shown. The system 10 can include a multi-media device 12 and a remote control device 14. These and other possible components of the system 10 will be described in turn below.

A “multi-media device” is defined as a device that is at least partially powered by electrical energy and that can present one or more forms of content to a user. Examples of such content forms can include text, audio, video, animation, still images and interactivity. The different content forms may be presented simultaneously or at different times on the multi-media device 12. In one embodiment, the multi-media device 12 can be a television 16, smart TV or connected TV. As an example, a smart TV or connected TV is a television set with Internet capabilities integrated therein. The multi-media device 12 can include a display 18 for presentation of content to a user. The display 18 can be any suitable type of display, such as a liquid crystal display (LCD), a light-emitting diode (LED) display or a plasma display panel (PDP).

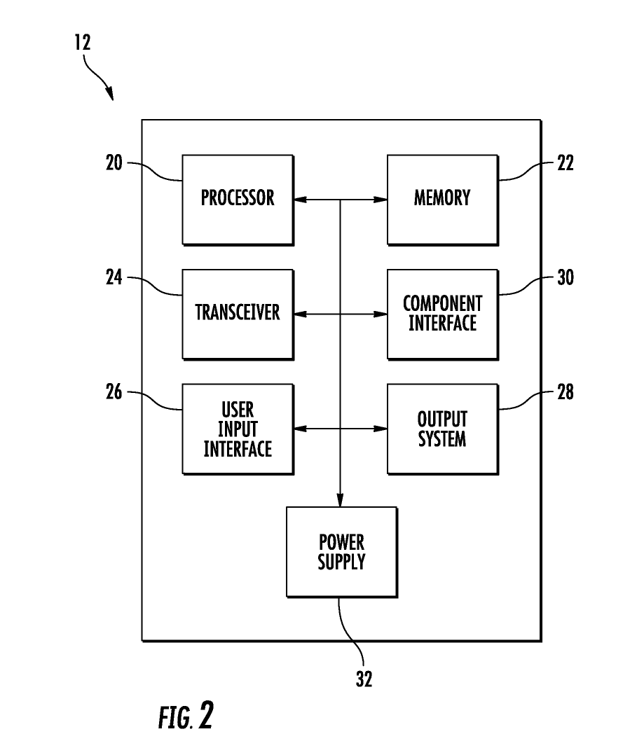

FIG. 2 shows a diagrammatic view of at least some of the components of the multi-media device 12. The multi-media device 12 can include a processor 20. The processor 20 may be implemented with one or more general-purpose and/or special-purpose processors. Examples of suitable processors include microprocessors, microcontrollers, DSP processors, and other circuitry that can execute software.

The multi-media device 12 can include memory 22 for storing various types of data. The memory 22 can include volatile and/or non-volatile memory. Examples of suitable memory 22 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 22 can be operatively connected to the processor 20 for use thereby. The term “operatively connected” can include direct or indirect connections, including connections without direct physical contact.

The multi-media device 12 can be operatively connected to the remote control device 14 in any suitable manner, including by a network. The term “network” is defined as one or more components designed to transmit and/or receive information from one source to another, including in a centrally-coordinated manner or in a peer-to-peer fashion. The transmission can be achieved in any suitable manner, such as by a hardwire connection or wirelessly. The multi-media device 12 can further include one or more transceivers 24. The transceiver 24 can be operatively connected to the processor 20 and/or the memory 22. In one embodiment, the transceiver 24 can be a wireless transceiver. Any suitable wireless transceiver can be used to wirelessly access a network or access point to transmit and receive data. The transceiver 24 may use any one of a number of wireless technologies. Examples of suitable transceivers include a cellular transceiver, a broadband internet transceiver, a local area network (LAN) transceiver, a wide area network (WAN) transceiver, a wireless local area network (WLAN) transceiver, a personal area network (PAN) transceiver, a body area network (BAN) transceiver, a WiFi transceiver, a WiMax transceiver, a Bluetooth transceiver, a 3G transceiver, a 4G transceiver, a ZigBee transceiver, a WirelessHART transceiver, a MiWi transceiver, an IEEE 802.11 transceiver, an IEEE 802.15.4 transceiver, or a Near Field Communication (NFC) transceiver, just to name a few possibilities.

The transceiver 24 can include any wireless technology developed in the future. In other exemplary embodiments, the multi-media device 12 may include one or more additional wireless transceivers (not shown) for accessing further wireless networks not accessible using the wireless transceiver 24. The multi-media device 12, including the transceiver 24, may communicate with an internet-based network according to any suitable communication protocols, including, for example, the Transmission Control Protocol and the Internet Protocol (TCP/IP), Transmission Control Protocol (TCP), User Datagram Protocol (UDP) and Universal Plug and Play (UPNP), just to name a few possibilities.

While much of the above discussion has been directed to embodiments in which the transceiver 24 is a wireless transceiver, it will be understood that embodiments are not limited to wireless transceivers. Indeed, the transceiver 24 may be configured for wired connections.

The multi-media device 12 can include a user input interface 26 for receiving input from a user. Any suitable user input interface 26 can be provided, including, for example, a keypad, display, touch screen, button, joystick, mouse, microphone or combinations thereof. The multi-media device 12 can include an output system 28 for presenting information to the user. The output system 28 can include the display 18. The output system 28 can also include an audio interface (not shown) that can include a microphone, earphone and/or speaker.

The multi-media device 12 may include a component interface 30. Additional elements can be operatively connected to the component interface 30, including, for example, a universal serial bus (USB) interface. The multi-media device 12 may include a power supply 32, which may be an internal or external source. As is shown in FIG. 1, the processor 20, the memory 22, the transceiver 24, the user input system 26, the output system 28, the component interface 30 and/or the power supply 32 can be operatively connected in any suitable manner.

The multi-media device 12 can be configured to display application software on the display 18. The term “application software” is defined as software or a related feature that is configured to help a user to perform one or more specific tasks. The application software can be for any purpose, including, reference, business, entertainment, education, and communication, just to name a few possibilities. The application software can be downloaded directly by the multi-media device 12, such as by transceiver 24. The downloaded application software can be stored directly on the multi-media device 12, such as in memory 22, or on some other suitable unit that the multi-media device 12 can access.

In some instances, the multi-media device 12 itself may not be able to download, access, execute and/or store application software. In such cases, a peripheral device 36 can be operatively connected to the multi-media device 12. The peripheral device 36 can be configured to download, access, execute and/or store application software. In one embodiment, the peripheral device 36 can be a set-top box 38 or set-top unit. The peripheral device 36 can also be a disc player or a game console. The peripheral device 36 can be any device that can operatively connect to a multi-media device 12 to provide content or application software programs thereto. The multi-media device 12 can access and/or execute application software resident on the peripheral device 36.

The peripheral device 36 can include a processor (not shown), memory (not shown), a transceiver (not shown), a user input interface (not shown), an output system (not shown), a component interface (not shown) and/or a power supply (not shown). The description of the processor 20, memory 22, the transceiver 24, the user input interface 26, the output system 28, the component interface 30 and the power supply 32 made above in connection with the multi-media device 12 is equally applicable to the similar components of the peripheral device 36. The peripheral device 36 can be operatively connected to the multi-media device 12 in any suitable manner, including, for example, by hardwire or wireless connections.

In some instances, the application software can be stored in a remote source 34, such as a server 40 or some other network component. The application software can be accessed from the remote source 34 by the multi-media device 12 and/or the peripheral device 36. The application software may be executed on the remote source 34, the multi-media device 12 and/or the peripheral device 36.

As noted above, the system 10 can include a remote control device 14. The remote control device 14 can be adapted to allow remote manipulation of at least some aspects of the multi-media device 12 and/or the peripheral device 36. The remote control device 14 can include a display 42 (see FIG. 1). The remote control device 14 can be any suitable device including, for example, a remote control, a cellular telephone, a smart phone, a personal digital assistant (“PDA”), a tablet computer 44 (FIG. 1), a digital reader, a handheld device having wireless connection capability, a computer (e.g., a laptop), a portable communication device, a portable computing device, an e-book reader, a camera or a game console. The remote control device 14 can be configured to communicate via a wireless or wired medium.

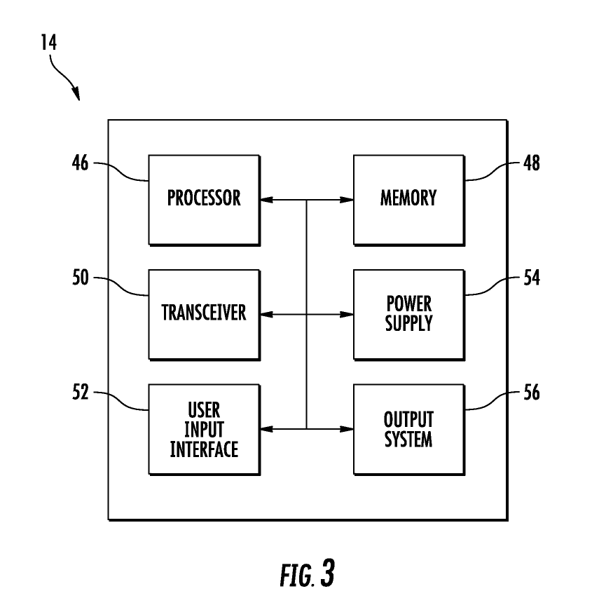

Referring to FIG. 3, an exemplary remote control device 14 is shown. The remote control device 14 can include a processor 46. The remote control device 14 may also include memory 48 for storing various types of data. The memory 14 can be operatively connected to the processor 12 for use thereby. The above-discussion of the processor 20 and memory 22 made in connection with the multi-media device 12 is equally applicable to the processor 46 and memory 48 of the remote control device 14.

The remote control device 14 can be operatively connected to the multi-media device 12 and/or the peripheral device 36 to transmit data thereto and receive data therefrom. The operative connection between the remote control device 14 and the multi-media device 12 and/or the peripheral device 36 can be achieved in any suitable wired or wireless manner. In instances in which the remote control device 14 is operatively connected wireles sly to the multi-media device 12 and/or the peripheral device 36, the remote control device 14 can further include a transceiver 50. The above-discussion of the transceiver 24 made in connection with the multi-media device 12 is equally applicable to the transceiver 50 of the remote control device 14. The transceiver 50 can be operatively connected to the processor 46 and/or the memory 48. The transceiver 50 of the remote control device 14 can transmit to and receive data from the transceiver 24 of the multi-media device, the transceiver (not shown) of the peripheral device and/or the remote source 34 (either through the multi-media device 12, the peripheral device 36 or through some other component).

The remote control device 14 can include a user input interface 52 for receiving input from a user and/or presenting information to the user. Any user input interface 52 can be used including the display 42, which can be a touch screen 43. The user input interface 52 may include additional elements, including, for example, a button, joystick, track ball, mouse or combinations thereof. The user input interface 52 may also include an audio interface that can include a microphone, earphone and/or speaker (not shown).

The remote control device 14 can be configured to access and/or execute application software thereon to enhance the user input interface 52. Such functionality can be provided by application software that is stored directly on the remote control device 14, such as in memory 48. Alternatively, the remote control device 14 can access and/or execute application software from an external source, such as the multi-media device 12, the peripheral device 36 and/or the remote source 34.

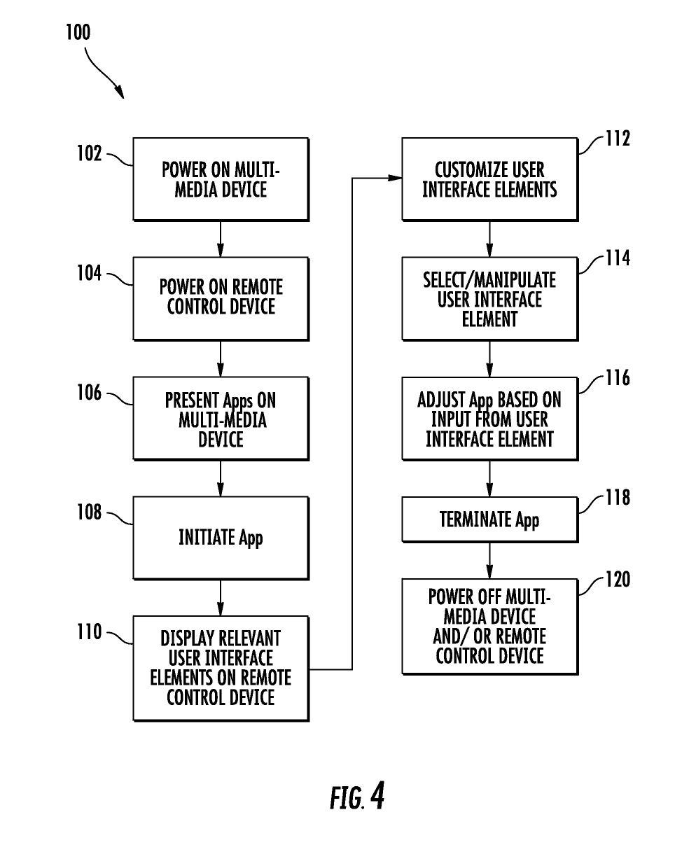

Now that various possible components of a system have been described, one manner of the operation of the system will now be described. The following description is merely provided as an example, and embodiments are not limited to the specific details and steps described. Referring to FIG. 4, an exemplary method 100 for providing an enhanced user interface for a remote control device. The method 100 illustrated in FIG. 4 may be applicable to the embodiments described above in relation to FIGS. 1-3, but it is understood that the method 100 can be carried out with other suitable systems and arrangements. Moreover, the method 100 may include other steps that are not shown here, and in fact, the method 100 is not limited to including every step shown in FIG. 4. The steps that are illustrated here as part of the method 100 are not limited to this particular chronological order, either.

At step 102, the multi-media device 12 can be powered on. At step 104, the remote control device 14 can be powered on. At step 106, one or more application software programs can be presented to the user by the multi-media device 12, such as on the display 18. The one or more application software programs can be presented on the multi-media device 12 in any suitable manner. For instance, the application software programs can be presented on the display 18 as icons for selection by the user.

Again, the application software may be resident on the multi-media device 12, the peripheral device 36 (if one is provided), the remote source 34 or combinations thereof. At step 108, the user can initiate an application software program. The application software program and any corresponding functions or operations may be displayed on the multi-media device 12.

Based on the application software program initiated in step 108, a set of user interface elements can be presented on the display of the remote control device at step 110. The term “user interface element” is defined as a user-perceivable element and any underlying code or instruction sets that enable a user or some other entity to manipulate or control one or more features of a related program or platform. The user interface elements can have any suitable form. The set of user interface elements can include one or more user interface elements. The set of user interface elements can be relevant to the application software program initiated in step 108. The term “relevant” means that the user interface elements are related to the initiated application software program such that manipulation of one or more of the element affects or manipulates at least some aspect or feature of the application software program.

As an example, the user may select a mapping application software program on the multi-media device 12. When the user initiates the mapping application software program on the multi-media device 12, a user interface can be presented on the display 42 of the remote control device 14. The user interface is relevant to the mapping application software program. For instance, the user interface can display a set of user interface elements, including, for example, a zoom bar, directional movement, return-to-last results button, satellite view, map view, and/or street level view, one or more of which can enable the user to affect or manipulate the mapping program.

In one embodiment, the set of user interface elements presented to the user in step 110 can be predetermined. Alternatively, in some instances, a plurality of user interface elements can be presented to the user for customization by the user. Thus, the user can select a set of desired user interface elements for use in connection with a particular application software program. The selected user interface elements can be stored on the remote control device 14, the multi-media device 12, the peripheral device 36 and/or the remote source 34. In such case, when the user subsequently initiates the application software program initiated in step 108, the selected user interface elements can be presented to the user. The user can have the option to change the selected user interface elements.

The set of user interface elements can be fixed for a particular application software program; that is, the set of user interface elements does not change for the particular software application initiated in step 106. Alternatively, the set of user interface elements can be dynamic. That is, the set of user interface elements can change as the content presented by the application software program changes or upon the occurrence of some event or condition.

At step 112, the user can manipulate the set of user interface elements. When the set of user interface elements comprises a plurality of user interface elements, step 112 can comprise manipulating at least one of the plurality of user interface elements. In response, the application software program can be adjusted in the directed manner at step 114. At step 116, the application software program may terminate by itself or at the direction of the user. If a second application software program is initiated, then the method 100 can return to step 110 and proceed therefrom. The user may power off the remote control and/or the multi-media device at step 118. It will be understood that the details of method 100 are exemplary, as some embodiments may include additional or fewer steps than those described above.

In one arrangement, one or more application software programs can be displayed and launched from the remote control device 14, and in response, relevant user interface elements can be displayed on the multi-media device 12. A user can then manipulate the user interface elements displayed on the multi-media device 12 to control related application software programs loaded on the remote control device 14. Moreover, the user can manipulate the user interface elements of the multi-media device 12 via controls that are part of the multi-media device 12 or through some other unit that is operatively connected to the device 12.

It will be appreciated that embodiments described herein can provide numerous benefits. Significantly, relevant user interface elements can be displayed to the user on the remote control device based on the application software program initiated on the multi-media device. In this way, the remote control device 14 can adapt to the content displayed on the multi-media device 12. Thus, user interaction with the remote control device 14 and/or the multi-media device 12 can be enhanced. It will also be appreciated that, in some instances, the remote control device 14 can be simplified, as the need to present a plurality of buttons and other user inputs may be diminished in view of the adaptive user interface presented on the display 18.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage medium, such as a computer-readable storage medium of a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects can be embodied in other forms without departing from the spirit or essential attributes thereof. Accordingly, reference should be made to the following claims, rather than to the foregoing specification, as indicating the scope of the invention.

What is claimed is:

1. A method for remotely controlling a multi-media device comprising:
initiating an application software program;
displaying the application software program on a multi-media device; and
presenting a set of one or more user interface elements on a remote control device that is operatively connected to the multi-media device, the set of user interface elements being relevant to the application software program.

2. The method of claim 1, wherein the presenting step comprises displaying the set of user interface elements on the remote control device.

3. The method of claim 1, wherein the set of user interface elements are fixed, whereby the set of user interface elements does not change during activation and operation of the application software program.

4. The method of claim 1, further including the step of modifying the set of user interface elements during activation or operation of the application software program.

5. The method of claim 1, further including the step of customizing the set of user interface elements.

6. The method of claim 1, further including the step of manipulating the set of user interface elements, whereby the application software program adjusts responsive to the manipulating step.

7. The method of claim 1, further including the step of accessing the set of user interface elements for the application software program from a source external to the remote control device.

8. The method of claim 1, further including the step of transmitting the set of user interface elements for the application software program from a source external to the remote control device.

9. The method of claim 1, wherein the set of user interface elements are stored on the remote control device, and further including the step of accessing the set of user interface elements from the remote control device.

10. The method of claim 1, wherein a processor initiates the application software program and the processor is included in at least one of the multi-media device, a peripheral device operatively connected to the multi-media device or a remote source.

11. A remote control device comprising:
a display; and
a transceiver for transmitting data to and receiving data from a multi-media device or a peripheral device operatively connected to a multi-media device; and
a processor that is operable to cause a set of one or more user interface elements to be presented on the display when an application software program is initiated for display on the multi-media device, the set of user interface elements being relevant to the application software program.

12. The device of claim 11, wherein the set of user interface elements is predetermined.

13. The device of claim 11, wherein the remote control device is a remote control, a laptop computer, a tablet computer or a smart phone.

14. The device of claim 11, wherein the transceiver is configured to at least one of access the set of user interface elements from a source external to the remote control device or receive the set of user interface elements transmitted from a source external to the remote control device.

15. The device of claim 11, wherein the remote control device further includes a memory, wherein the set of user interface elements are stored in the memory, and wherein the processor accesses the set of user interface elements from the memory for presentation on the display when an application software program is initiated for display on the multi-media device.

16. A remote control system comprising:
a multi-media device having a display;
a processor for initiating an application software program for display on the multi-media device; and
a remote control device including:
a display; and
a transceiver configured to transmit data to and receive data from the multi-media device,
the remote control device being configured to present a set of user interface elements on the display when an application software program is initiated for display on the multi-media device, the set of user interface elements being relevant to the application software program, whereby the application software program is responsive to manipulation of the user interface elements.

17. The system of claim 16, further including a peripheral device operatively connected to the multi-media device, wherein the processor is resident in the peripheral device, and wherein the transceiver is configured to transmit data to and receive data from the peripheral device.

18. The system of claim 16, wherein the peripheral device is a set-top box.

19. The system of claim 16, wherein the processor is resident in the multi-media device.

20. The system of claim 16, wherein the set of user interface elements are stored in a source external to the remote control device, and wherein the remote control device is configured to access the set of user interface elements from the source or receive the set of user interface elements from the source.

21. A multi-media device comprising:
a display for presenting application software programs thereon; and
a transceiver for transmitting data to and receiving data from a remote control device that is operatively connected to the multi-media device,
wherein launching an application software program for display on the multi-media device causes a set of one or more user interface elements that are relevant to the application software program to be displayed on the remote control device.

22. The device of claim 21, further including a processor for accessing or executing an application software program, the processor being operatively connected to the transceiver.

23. The device of claim 22 further including memory having an application software program stored therein, the processor being operatively connected to access the application software program stored in the memory.

24. The device of claim 21, wherein the transceiver is configured to transmit the set of user interface elements to the remote control device.

25. The device of claim 21, wherein the transceiver is configured to access the set of user interface elements from a source external to the multi-media device.
